(19) United States
(12) Patent Application Publication
(10) Pub. No.: US 2022/0167720 A1
(43) Pub. Date: Jun. 2, 2022

(54) ADD-ON MEDICINE CARRIERS FOR MOBILE DEVICES AND METHODS THEREOF

(71) Applicant: Paul REGAN, Brampton (CA)

(72) Inventor: Paul REGAN, Brampton (CA)

(21) Appl. No.: 17/540,020

(22) Filed: Dec. 1, 2021

Related U.S. Application Data
(60) Provisional application No. 63/120,339, filed on Dec. 2, 2020.

(51) Int. Cl. A45C 11/00; A61J 1/03

(52) U.S. Cl. CPC A45C 11/00; A45C 2011/002; A45C 2011/007; A61J 1/03

(57) ABSTRACT

An add-on medicine carrier comprising a container, a lid structure and an attachment mechanism. The container has at least one sidewall coupled adjacent one end to a base wall to define a chamber sized to receive at least one dose of a medication. The lid structure is configured to detachably mate adjacent to an opposing end the one or more sidewalls. The attachment mechanism is on an outer surface of the base wall to detachably secure the container to a surface of a mobile device.

This application claims benefit of U.S. Provisional Patent Application No. 63/120,339, filed Dec. 2, 2020, the entirety of which is incorporated herein by reference.

### FIELD

This technology relates generally to the field of add-ons for mobile phones or devices and, more particularly, to an add-on medicine carrier that can be adhered to a mobile device, such as a mobile phone or phone case.

### SUMMARY

An add-on medicine carrier includes a container, a lid structure and an attachment mechanism. The container has at least one sidewall coupled adjacent one end to a base wall to define a chamber sized to receive at least one dose of a medication. The lid structure is configured to detachably mate adjacent to an opposing end the one or more sidewalls. The attachment mechanism is on an outer surface of the base wall to detachably secure the container to a surface of a mobile device.

A method for making an add-on medicine carrier includes coupling at least one sidewall adjacent one end to a base wall to define a container with a chamber sized to receive at least one dose of a medication. A lid structure configured to detachably mate adjacent to an opposing end the one or more sidewalls is formed. A attachment mechanism is provided on an outer surface of the base wall to detachably secure the container to a surface of a mobile device.

This technology provides a number of advantages including providing an add-on medicine carrier that can be easily adhered to a mobile device, such as a mobile phone or phone case. As illustrated in these examples, these illustrative add-on medicine carriers enable secure, but easy and convenient access to medication, if and when needed. Additionally, examples of these add-on medicine carriers are designed for easy detachable attachments to a mobile device in an unobtrusive manner.

### BRIEF DESCRIPTION OF THE DRAWINGS

FIG. 1 is a perspective view of an example of a circular-shaped, add-on medicine carrier in an open configuration, and a closed and adhered configuration to an exemplary smart phone.

FIG. 2 is a perspective view of an example of a square-shaped, add-on medicine carrier in an open configuration, and a closed and adhered configuration.

FIG. 3 is a perspective view of an example of another square-shaped, add-on medicine carrier in an open configuration, and a closed and adhered configuration to a phone or keychain.

FIG. 4 is a perspective view of another example of the square-shaped, add-on medicine carrier shown in FIG. 3 in an open configuration, and a closed and adhered configuration to a phone or keychain.

### DETAILED DESCRIPTION

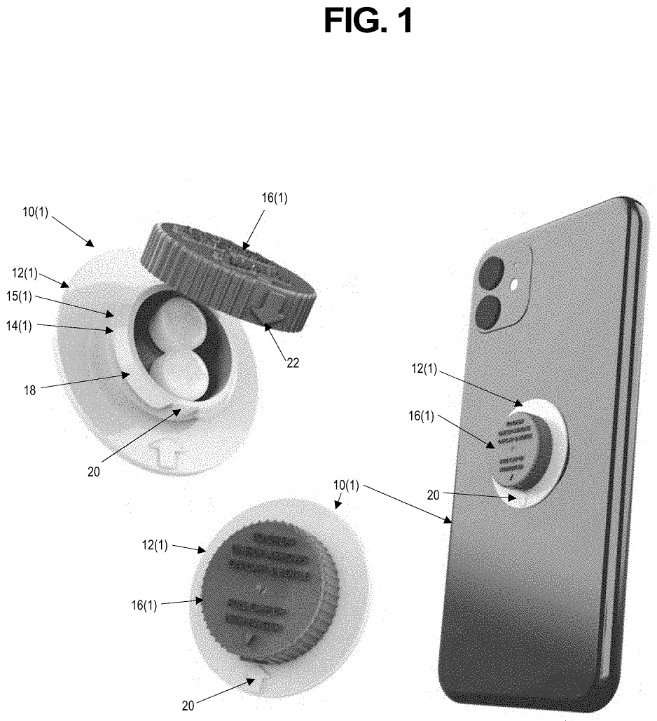

Examples of portable medicine carriers 10(1)-10(4) for use with mobile phones, phone cases, or other mobile devices are illustrated in FIGS. 1-4. Each of these portable medicine carriers 10(1)-10(4) includes a corresponding one of the base walls or other supporting surface 12(1)-12(3), the containers 14(1)-14(3), and lid structures 16(1)-16(3), although each could have other types and/or numbers of other components and/or other elements in other configurations. This technology provides a number of advantages including providing add-on medicine carriers that can easily be adhered to a mobile device, such as a mobile phone or phone case.

Referring more specifically to FIG. 1, an example of a circular-shaped, add-on medicine carrier 10(1) in an open configuration, and a closed and adhered configuration to an exemplary smart phone is illustrated. In this example, the circular-shaped, add-on medicine carrier 10(1) includes a base wall or other supporting surface 12(1), a container 14(1), and a lid structure 16(1), although the circular-shaped, add-on medicine carrier 10(1) could have other types and/or numbers of other components and/or other elements in other configurations.

The base wall or other supporting surface 12(1) provides one surface with an area that supports the container 14(1) and lid structure 16(1) and an opposing surface from the container 14(1) that provides another area that may be partially or fully coated with an adhesive to enable the add-on medicine carrier 10(1) to be secured to a mobile device, such as a smart phone as illustrated in this example, although other types of support structures may be used with other types of attachment mechanisms. In this example, the base wall or other supporting surface 12(1) has a circular-shape and advantageously extends beyond the outer perimeter of the circular-shaped container 14(1) to provide an extended surface area for establishing a secure connection with the mobile device, although dimensions, shapes, and/or manners for attaching may be used. Additionally, examples of this technology may also be integrated into expandable mobile phone stands. Further, in addition to phone related applications, examples of this technology can also be applied to other surfaces such gym lockers, car dashes, toolboxes, first aid kits or any other area desired by a user to provide portable storage and access to medications.

The container 14(1) coupled to or integrally formed with the base wall or other supporting surface 12(1) has a circular-shaped sidewall 15(1) coupled adjacent one end or edge the base wall or other supporting surface 12(1) which defines a chamber sized to receive at least one dose of a medication, such as one or more pills as illustrated. Although the container 14(1) is shown with a single sidewall 15(1) in a circular-shape, the container could have other types and/or numbers of sidewalls in other shapes that define other sized chambers configured to store medicine. Additionally, in this example the sidewall 15(1) has a concave shape which is sized to fit between one or more fingers of a human hand below the lid structure, although the sidewall could have other shapes. Further in this and other examples the sidewall 15(1) (or sidewalls in other examples) may be designed to allow the height of the sidewall or sidewalls to be expanded and retracted as needed, for examples in an accordian format, to a height to also faciltate use of the add-on medicine carrier as a support mechanism for the device the add-on medicine carrier is coupled to which can be in conjunction with or without the concave shape for the sidewall(s).

The lid structure 16(1) is configured as a cap for the container and is shaped and sized to detachably mate adjacent to an opposing end the sidewall of the container 14(1). In this example, the circular-shaped sidewall 15(1) of the container 14(1) has a lip 18 extending at least partially around that is configured to detachably engage with and mate with at least one projection 22 at least partially around on an inner surface of the lid structure 16(1) to from a detachable securing or locking mechanism for the lid structure 16(1) to the container 14(1), although other manners for securing the lid structure 16(1) to the container 14(1) could be used, such as other types of thread structures or snap-and-lock configurations by way of example. In this example, the detachable securing or locking mechanism may further include at least one gap 20 in the at least one lip 18 extending at least partially around the outer edge of the circular-shaped sidewall 15(1) of the container 14(1) that is sized to receive the projection 22 on the inner surface of the cap of the lid structure 16(1) when properly aligned as guided by the arrow illustrated in FIG. 1, although other configurations may be used. Further in this example, this locking structure detachably secures the lid structure 16(1) to the container 14(1) when the at least one gap 20 and the at least one projection 22 are not aligned and releases the lid structure 16(1) from the container 14(1) when the at least one gap and the at least one projection are aligned.

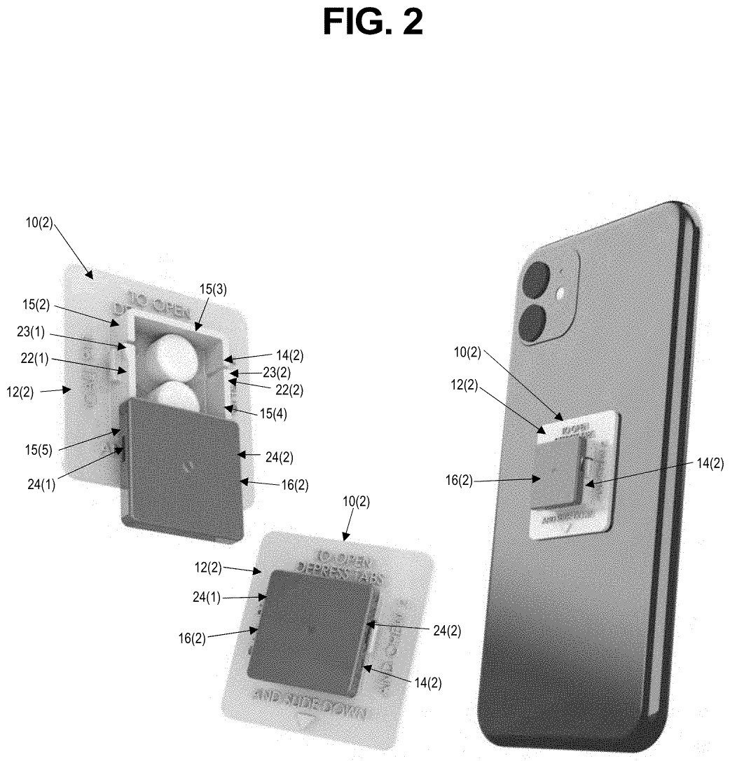

Referring to FIG. 2, an example of a square-shaped, add-on medicine carrier 10(2) in an open configuration, and a closed and adhered configuration to an exemplary smart phone is illustrated. In this example, the square-shaped, add-on medicine carrier 10(2) includes a base wall or other supporting surface 12(2), a container 14(2), and a lid structure 16(2), although the square-shaped, add-on medicine carrier 10(2) could have other types and/or numbers of other components and/or other elements in other configurations.

The base wall or other supporting surface 12(2) provides one surface with an area that supports the container 14(2) and lid structure 16(2) and an opposing surface from the container 14(2) that provides another area that may be partially or fully coated with an adhesive to enable the add-on medicine carrier 10(2) to be secured to a mobile device, such as a smart phone as illustrated in this example, although other types of support structures may be used with other types of attachment mechanisms. In this example, the base wall or other supporting surface 12(2) has a square-shape and advantageously extends beyond the outer perimeter of the square-shaped container 14(2) to provide an extended surface area for establishing a secure connection with the mobile device, although dimensions, shapes, and/or manners for attaching may be used.

The container 14(2) is coupled to or integrally formed with the base wall or other supporting surface 12(2) and in this example has a four sidewalls 15(2)-15(5) coupled or otherwise integarally formed to define a square-shaped a chamber sized to receive at least one dose of a medication, such as one or more pills as illustrated. Although the container 14(2) is shown with four sidewalls 15(2)-15(5) in a square-shape, the container could have other types and/or numbers of sidewalls in other shapes that define other sized chambers configured to store medicine.

Additionally, in this example at least two of the opposing sidewalls 15(2) and 15(4) each have a concave shape which is sized to fit between one or more fingers of a human hand below the lid structure, although one or more of the four sidewalls 15(2)-15(5) could have other shapes.

The lid structure 16(2) is configured as a slide on cap for the container and is shaped and sized to detachably mate adjacent to an opposing end the sidewall of the container 14(2). In this example, the opposing sidewall 15(2) and 15(4) of the container 14(2) have internal tracks configured to detachably engage with and mate with corresponding tracks on an inner surface of the lid structure 16(2) to detachable secure the lid structure 16(2) to the container 14(2), although other manners for securing the lid structure 16(2) to the container 14(2) could be used.

In this example, a locking mechanism is formed on flexible arms 22(1)-22(2) extending along the outer edge of opposing ones of the sidewalls 15(2) and 15(4) with a protrusion 23(1)-23(2) on each extending away from one end of each of the flexible arms 22(1)-22(2) and openings 24(1)-24(2) in opposing edges of the lid structure 16(2) are sized to detachably mate with a corresponding one of the protusions 23(1)-23(2). Further in this example, this locking structure detachably secures the lid structure 16(2) to the container 14(2) when the the flexible arms 22(1)-22(2) are bent by sliding movement of the lid structure 16(2) onto the container 14(2) and the protrusions 23(1)-23(2) are detachably seated in the openings 24(1)-24(2). This example of this locking structure detachably releases the lid structure 16(2) from the container 14(2) when the flexible arms 22(1)-22(2) are bent inward into the container 14(2) to release the protrusions 23(1)-23(2) from the openings 24(1)-24(2) so the lid structure 16(2) can be slid back to expose the square-shaped chamber in the container 14(2). Further, other types of child resistant locking mechanisms, such as those that require two different types of actions to release the lid structure from the container may be used.

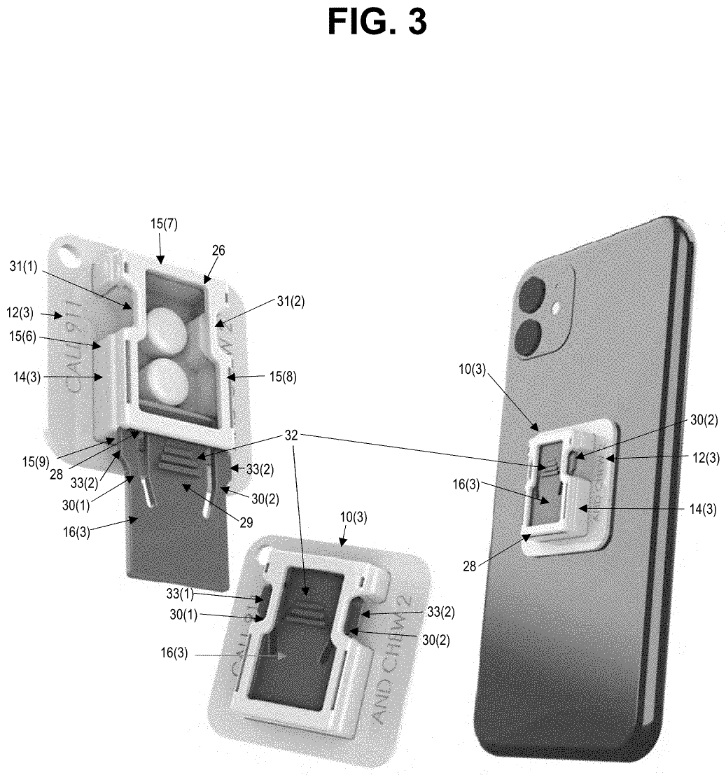

Referring to FIG. 3, an example of another square-shaped, add-on medicine carrier 10(3) in an open configuration, and a closed and adhered configuration to an exemplary smart phone is illustrated. In this example, the square-shaped, add-on medicine carrier 10(3) includes a base wall or other supporting surface 12(3), a container 14(3), and a lid structure 16(3), although the square-shaped, add-on medicine carrier 10(3) could have other types and/or numbers of other components and/or other elements in other configurations.

The base wall or other supporting surface 12(3) provides one surface with an area that supports the container 14(3) and lid structure 16(3) and an opposing surface from the container 14(3) that provides another area that may be partially or fully coated with an adhesive to enable the add-on medicine carrier 10(3) to be secured to a mobile device, such as a smart phone as illustrated in this example, although other types of support structures may be used with other types of attachment mechanisms. In this example, the base wall or other supporting surface 12(3) has a square-shape and advantageously extends beyond the outer perimeter of the square-shaped container 14(3) to provide an extended surface area for establishing a secure connection with the mobile device, although dimensions, shapes, and/or manners for attaching may be used.

The container 14(3) is coupled to or integrally formed with the base wall or other supporting surface 12(3) and in this example has a four sidewalls 15(6)-15(9) coupled or otherwise integarally formed to define a square-shaped a chamber sized to receive at least one dose of a medication, such as one or more pills as illustrated. Although the container 14(3) is shown with four sidewalls 15(6)-15(9) in a square-shape, the container could have other types and/or numbers of sidewalls in other shapes that define other sized chambers configured to store medicine. Additionally, in this example at least two of the opposing sidewalls 15(6) and 15(8) each have a concave shape which is sized to fit between one or more fingers of a human hand below the lid structure, although one or more of the four sidewalls 15(6)-15(9) could have other shapes and other numbers of sidewalls can be used in other examples.

The lid structure 16(3) is configured as a slide on tab for the container 14(3) and is shaped and sized to detachably mate in an opening 28 in the sidewall 15(9) of the container 14(3) in this example. Additionally in this example, the opposing sidewall 15(6) and 15(8) of the container 14(3) have internal tracks configured to detachably engage with sides of the tab for the lid structure 16(3) to detachable secure the lid structure 16(2) to the container 14(2), although other manners for securing the lid structure 16(2) to the container 14(2) could be used.

In this example, a locking mechanism is formed with flexible arms 30(1)-30(2) extending along the sides of the tab for the lid structure 16(3) with a protrusion 33(1)-33(2) on each extending away from one end of each of the flexible arms 30(1)-30(2) and openings 31(1)-31(2) in opposing sidewalls 15(6) and 15(8) of the container 14(3) which are sized to detachably mate with a corresponding one of the protusions 33(1)-33(2). Further in this example, this locking structure detachably secures the lid structure 16(3) to the container 14(3) when the the flexible arms 30(1)-30(2) are bent by sliding movement of the lid structure 16(3) into the container 14(3) and the protrusions 33(1)-33(2) are detachably seated in the openings 30(1)-30(2). This example of this locking structure detachably releases the lid structure 16(3) from the container 14(3) when the flexible arms 30(1)-30(2) are bent inward into the container 14(3) to release the protrusions 33(1)-33(2) from the openings 30(1)-30(2) so the lid structure 16(3) can be slid back to expose the square-shaped chamber in the container 14(3). Further, other types of child resistant locking mechanisms, such as those that require two different types of actions to release the lid structure from the container may be used.

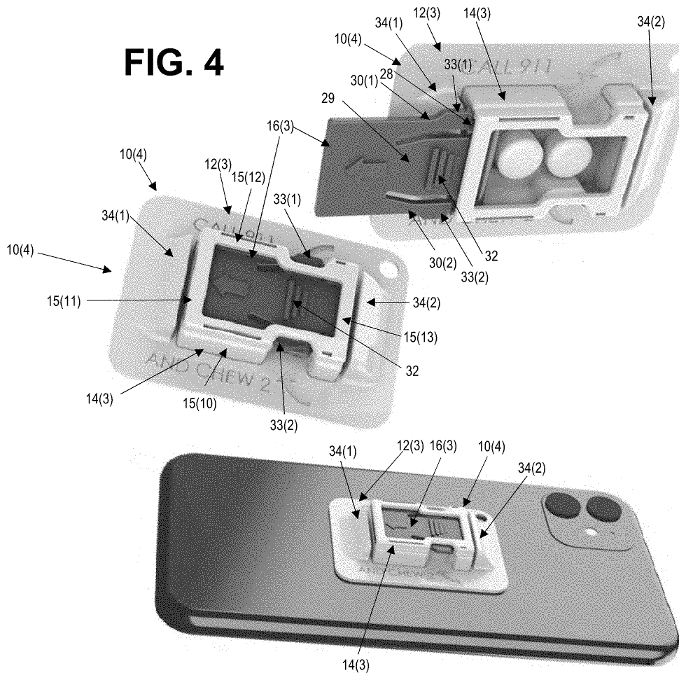

Referring to FIG. 4, another example of a square-shaped, add-on medicine carrier 10(4) in an open configuration, and a closed and adhered configuration to a phone or keychain is illustrated. In this particular example, the square-shaped, add-on medicine carrier 10(4) has the same structure and operation as the square-shaped, add-on medicine carrier 10(3), except as otherwise illustrated and/or described herein. In particular, in this example the square-shaped, add-on medicine carrier 10(4) again includes the base wall or other supporting surface 12(3), the container 14(3), and the lid structure 16(3) along with the beveled sections 34(1)-34(2), although the square-shaped, add-on medicine carrier 10(4) could have other types and/or numbers of other components and/or other elements in other configurations. In this example, the beveled sections 34(1)-34(2) are added to smooth the transition to the canister 14(3) on each side, although other types and/or numbers of other ergonomic strutural features may be added. Each of these add-on medicine carriers 10(1)-10(4) can be constructed as illustrated and described by way of the examples herein.

As illustrated in these examples, this technology provides medicine carriers for secure, but easy access to medication if and when needed. Additionally, the medicine carriers are designed for detachable attachments to phone case or phones, by way of example, to ensure necessary medications are close at hand if and when needed.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. An add-on medicine carrier comprising:
a container comprising at least one sidewall coupled adjacent one end to a base wall to define a chamber sized to receive at least one dose of a medication;
a lid structure configured to detachably mate adjacent to an opposing end the one or more sidewalls; and
an attachment mechanism on an outer surface of the base wall to detachably secure the container to a surface of a mobile device.

2. The apparatus as set forth in claim 1 wherein the at least one sidewall defines a circular circumference for the container with at least one lip extending at least partially around an outer edge of the at least one sidewall configured to detachably mate with at least one projection at least partially around on an inner surface of the lid structure.

3. The apparatus as set forth in claim 2 further comprising a locking structure comprising at least one gap in the at least one lip extending at least partially around the outer edge of the at least one sidewall and the at least one projection, wherein the locking structure detachably secures the lid structure to the container when the at least one gap and the at least one projection are not aligned and releases the lid structure from the container when the at least one gap and the at least one projection are aligned.

4. The apparatus as set forth in claim 2 wherein the at least one sidewall has a concave shape and sized to fit between one or more fingers of a human hand below the lid structure.

5. The apparatus as set forth in claim 1 wherein the at least one sidewall comprises at least four sidewalls which define the container with at least one lip extending at least partially along an outer edge of at least two of the sidewalls configured to slidably and detachably mate with at least one other lip extending at least partially along opposing inner surfaces of the lid structure.

6. The apparatus as set forth in claim 5 further comprising a locking structure comprising at least one flexible arm extending along the outer edge of opposing ones of the sidewalls with a protrusion extending away from one end of each of the flexible arms and at least one opening in opposing edges of the lid structure sized to detachably mate with a corresponding one of the protusions.

7. The apparatus as set forth in claim 5 further comprising a locking structure comprising at least one opening in opposing sidewalls and at least one flexible arm extending along opposing outer edges of the lid structure with a protrusion extending away from one end of each of the flexible arms, wherein the at least one opening in each of the opposing ones of the sidewalls are sized to detachably mate with a corresponding one of the protusions of the lid structure.

8. The apparatus as set forth in claim 5 further comprising beveled sections each sloping away from one of opposing ones of the sidewalls.

9. A method for making an add-on medicine carrier, the method comprising:
coupling at least one sidewall adjacent one end to a base wall to define a container with a chamber sized to receive at least one dose of a medication;
forming a lid structure configured to detachably mate adjacent to an opposing end the one or more sidewalls; and
providing an attachment mechanism on an outer surface of the base wall to detachably secure the container to a surface of a mobile device.

10. The method as set forth in claim 9 wherein the at least one sidewall defines a circular circumference for the container with at least one lip extending at least partially around an outer edge of the at least one sidewall configured to detachably mate with at least one projection at least partially around on an inner surface of the lid structure.

11. The method as set forth in claim 10 further comprising providing a locking structure comprising at least one gap in the at least one lip extending at least partially around the outer edge of the at least one sidewall and the at least one projection, wherein the locking structure detachably secures the lid structure to the container when the at least one gap and the at least one projection are not aligned and releases the lid structure from the container when the at least one gap and the at least one projection are aligned.

12. The method as set forth in claim 10 wherein the at least one sidewall has a concave shape and sized to fit between one or more fingers of a human hand below the lid structure.

13. The method as set forth in claim 9 wherein the at least one sidewall comprises at least four sidewalls which define the container with at least one lip extending at least partially along an outer edge of at least two of the sidewalls configured to slidably and detachably mate with at least one other lip extending at least partially along opposing inner surfaces of the lid structure.

14. The method as set forth in claim 13 further comprising providing a locking structure comprising at least one flexible arm extending along the outer edge of opposing ones of the sidewalls with a protrusion extending away from one end of each of the flexible arms and at least one opening in opposing edges of the lid structure sized to detachably mate with a corresponding one of the protusions.

15. The method as set forth in claim 13 further comprising providing a locking structure comprising at least one opening in opposing sidewalls and at least one flexible arm extending along opposing outer edges of the lid structure with a protrusion extending away from one end of each of the flexible arms, wherein the at least one opening in each of the opposing ones of the sidewalls are sized to detachably mate with a corresponding one of the protusions of the lid structure.

16. The method as set forth in claim 13 further comprising forming beveled sections each sloping away from one of opposing ones of the sidewalls.
